(19) United States
(12) Patent Application Publication
(10) Pub. No.: US 2010/0213889 A1
(43) Pub. Date: Aug. 26, 2010

(54) Method of recharging a caddy cart battery

(75) Inventor: Andrew O'Reilly, Dublin (IE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Andrew O'Reilly, Dublin (IE)

(21) Appl. No.: 11/922,037

(22) PCT Filed: Aug. 19, 2005
(86) PCT No.: PCT/IE2005/000084

§ 371 Date: Dec. 12, 2007

(30) Foreign Application Priority Data
Aug. 21, 2004 (GB) 0418684.7

(51) Int. Cl. H02J 7/00

(52) U.S. Cl. 320/105; 320/103

(57) ABSTRACT

A method of recharging a caddy cart battery, comprises a step of connecting the caddy cart battery to an electrical supply of a vehicle to thereby charge the caddy cart battery. The method employs an electronic charge varying device to decrease the electrical supply to the caddy cart battery when it is recharged, wherein the charge passing from the vehicle battery to the caddy cart battery passes through the charge varying device. The invention also relates to a kit for carrying out the method of the invention, and a vehicle incorporating means for re-charging a caddy cart battery.

### TECHNICAL FIELD

The invention relates to a method of, and kit for, recharging a caddy cart battery.

### BACKGROUND ART

Caddy carts are widely used nowadays on golf courses as a means of easily transporting a golf bag around a golf course. Generally, such caddy carts comprise a conventional golf cart which is modified to include an electric motor which drives the wheels of the cart, and a rechargeable, removable, battery which powers the motor. An example of such a caddy cart is sold under the brand name POWAKADDY™. The batteries are usually designed to provide a sufficient amount of power to allow a user power a golf cart around a standard 18 hole golf course before the battery needs to be recharged.

Currently, the batteries are provided with adapters which allow a user recharge the battery from a standard domestic electrical socket, such as the S-pin socket commonly employed in domestic dwellings in the UK and Ireland. In order for the battery to be recharged in this manner, it must first be removed from the caddy cart, brought into a user's house or garage, then plugged in and allowed to recharge over a period of time. The battery must then be brought back out to the car, and re-deposited in the caddy cart which is usually folded down in the boot of the users car. This is a laborious task, not least because of the weight of the battery (most batteries weigh in the region of about 5 kg), but also because the caddy cart needs to be unfolded prior to insertion of the battery.

It is an object of the invention to overcome at least some of the above-referenced problems.

### STATEMENTS OF INVENTION

According to the invention, there is provided a method of recharging a caddy cart battery, comprising the step of connecting the caddy cart battery to an electrical supply of a vehicle to thereby charge the caddy cart battery.

In this manner, the caddy cart battery can be re-charged in the vehicle without having to remove it from the vehicle and bring it to a domestic electricity supply. Obviously, this arrangement removes a lot of the effort and inconvenience heretofore required when recharging a caddy cart battery.

In this specification, the term vehicle, or passenger vehicle, is intended to mean a vehicle which is used to carry passengers such as, for example, a car, motorbike, van, truck, coach and the like

Typically, the caddy cart battery is connected directly to the vehicle battery. Generally, such vehicle batteries are found in the engine compartment of a vehicle. When the vehicle is a car, the engine compartment is usually located at the front of the car.

Generally, the method involves use of an electronic charge varying device to decrease the electrical supply to the caddy cart battery when the caddy cart battery is recharged, wherein the charge passing from the vehicle battery to the caddy cart battery passes through the cut-off relay. Typically, the charge varying device has two settings, a first “full charge” setting in which a full charge of electricity from the vehicle battery is supplied to the caddy cart battery, and a “trickle charge” setting which allows only a small amount of charge to be supplied to the caddy cart battery. Typically, the charge varying device senses the charge required by the battery, and adapts the charge setting accordingly. The charge varying device may comprise a plurality of relays, typically fabricated upon a printed circuit board (PCB).

In a preferred embodiment, the method employs an electrical cable having a first end which is adapted to make an electrical connection with a battery of a passenger vehicle, and a second end which is adapted to make an electrical connection with a caddy cart battery. The connection with the caddy cart battery may be a direct connection, in which the electrical cable connects to the lead of the battery, or the cable may make connection with an adaptor, lead or other electrical component which itself is connected to the caddy cart battery.

In one embodiment, the method involves use of a cradle for the caddy cart battery, wherein the caddy cart battery is placed in the cradle, before re-charging the caddy cart battery. Typically, such a cradle is fixed to a vehicle, ideally a boot compartment of the vehicle. In this manner, the battery will be prevented from moving about the vehicle during re-charging of the battery.

The invention also relates to a kit for re-charging a caddy cart battery comprising an electrical cable which is adapted to make an electrical connection between a vehicle battery and a caddy cart battery, and instructions for recharging the caddy cart battery from the vehicle battery using the electrical cable.

Typically, the electrical cable has a first end that is adapted to make an electrical connection with a passenger vehicle battery, and a second end which is adapted to provide charge to a caddy cart battery. Suitably, instructions for electrically connecting the vehicle battery and the caddy cart battery using the electrical cable are provided.

Typically, the kit includes an electronic charge varying device (as described above) to decrease the electrical supply to the caddy cart battery when the caddy cart battery is recharged.

In one embodiment, the cut-off relay is provided in-line in the electrical cable.

In a preferred embodiment, the kit includes a cradle which is dimensioned to receive a caddy car battery. Typically, the cradle is adapted to be fixed to a vehicle, typically a boot compartment of the vehicle. The cradle may also be fixed to a footwell of the vehicle, or in an engine compartment of the vehicle.

In one embodiment of the invention, the electronic charge varying device is provided on the cradle, wherein the device is adapted for making an electrical connection with the electrical cable and the caddy cart battery.

In a preferred embodiment of the invention, the kit includes a charge level indicator which is adapted to provide an indication of a level of charge of the caddy cart battery. Typically, the charge level indicator is provided on the cradle. Suitably, the indicator provides a visual signal.

In a preferred embodiment of the invention; the electrical cable is of a sufficient length to reach from a battery of a passenger vehicle to a boot of the passenger vehicle Generally, with cars, the cable will need to be of a sufficient length to lead from the engine compartment of the car, which is usually in the front of the car, along the bulkhead, to a boot of a car.

Typically, the kit of the invention further includes:
at least one adapter for making an electrical connection between a first end of the electrical cable and a passenger vehicle battery;
at least one adapter for making an electrical connection between the second end of the electrical cable and either of the caddy cart battery, an adapter for the caddy cart battery, or an electronic charge varying device in electrical connection with the caddy cart battery.

Ideally, the kit will include at least two adapters for making an electrical connection between a first end of the electrical cable and a passenger vehicle battery. Suitably, the kit will include at least two adapters for making an electrical connection between the second end of the electrical cable and the caddy cart battery, or an adapter for the caddy cart battery, or a charge varying device in electrical connection with the caddy cart battery. The provision, in the kit of two or more adapters allows the kit be used with different types of vehicle and caddy cart batteries, which often have different designs of electrical terminals, or different battery'leads/adapters.

The instructions provided with the kit of the invention will ideally instruct a user how to install the kit in a car. Typically, the instructions will direct the user to run the electrical cable along the back light wiring loom to the boot compartment. Typically, the instructions will direct a user to fix the cradle for the caddy cart battery to an interior of a boot compartment of the car. The kit may comprise a cut of switch arranged to prevent the flow of electricity from the passenger vehicle battery to the caddy cart battery when the boot of the passenger vehicle is opened.

The invention also relates to a passenger vehicle comprising a kit according to the invention which has been installed in the car.

The invention also relates to a passenger vehicle comprising an electrical cable which is adapted to provide charge from a battery of the passenger vehicle to a battery of a caddy cart, and, optionally, instructions for recharging a caddy cart battery using the electrical cable. Suitably, an end of the electrical cable which is adapted to provide charge to the caddy cart battery is located in a boot of the passenger vehicle. Suitably, the passenger vehicle further includes a socket located in the boot of the vehicle, which socket is dimensioned to receive the caddy cart battery. In a further embodiment, the passenger vehicle further includes an electronic charge varying device which is adapted to decrease the electrical supply to the caddy cart battery when the caddy cart battery is recharged. Ideally, the device has a first setting which allows full electrical charge to be supplied to the caddy car battery when the caddy cart battery is being recharged, and a second setting which allows a trickle charge to the caddy cart battery when it is recharged.

### BRIEF DESCRIPTION OF THE FIGURES

The invention will be more clearly understood from the following description of some embodiments thereof, given by way of example only, with reference to the accompanying Figures in which:

FIG. 1 is an illustration of an embodiment of the present invention;

FIG. 2 is an illustration of a second embodiment of the present invention;

FIG. 3 is an illustration of a third embodiment of the invention;

FIG. 4 is a circuit diagram of a circuit layout of an embodiment of printed circuit board comprising an aspect of the present invention;

FIG. 5 is a circuit diagram of a relay circuit of the printed circuit board of FIG. 4;

FIG. 6 is a circuit diagram of a relay of the relay circuit of FIG. 5;

FIG. 7 is a circuit diagram of a voltage regulation circuit of the printed circuit board of FIG. 4;

FIG. 8 is a circuit diagram of a boot light switch circuit of the printed circuit board of FIG. 4;

FIG. 9 is a circuit diagram of a charge level indicator light emitting diodes of the printed circuit board of FIG. 4;

FIG. 10 is a circuit diagram of an earthing circuit of the printed circuit board of FIG. 4; and

FIGS. 11a to 11d are partial circuit diagrams of a cigarette lighter fitting circuit of a cradle comprising an aspect of the present invention.

### DETAILED DESCRIPTION OF THE INVENTION

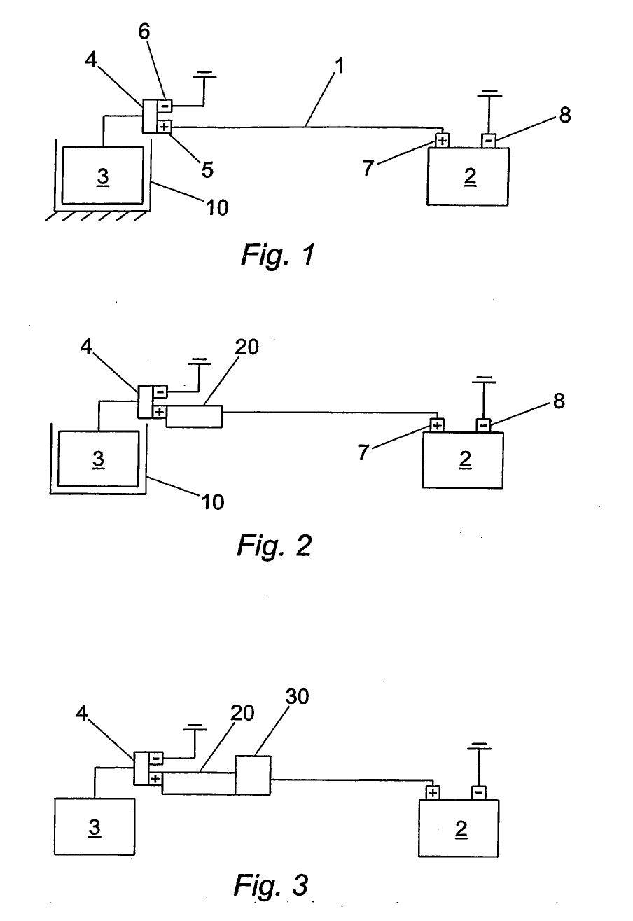

Referring to the Figures, and initially to FIG. 1, there is illustrated a first way of carrying out the method of the invention, in which an electrical cable 1 is used to provide an electrical connection between a cart battery 2 located in an engine compartment of a car (not shown) and a caddy cart battery 3 located in a car boot (not shown). The caddy cart battery 3 includes an adapter 4 having positive and negative terminals 5, 6, the positive terminal 5 being connected to a positive terminal 7 of the cart battery. The negative terminal 8 of the cart battery is connected to earth, as is the negative terminal 6 of the adapter 4. The caddy cart battery 3 is nested in a cradle 10 which is fixed to a floor of the boot (not shown). The details of such caddy cart cradles will be well known to those skilled in the art, and will not be described in any detail herein.

In use, the caddy cart battery 3 is removed from a caddy cart when it needs to be re-charged and is inserted into the cradle 10. The positive and negative terminals 5, 6 of the caddy cart battery adapter 4 are then connected to the electrical cable 1 and earth, respectively. As soon as an electrical connection is made between the car battery 2 and the caddy cart battery, the caddy cart battery will start to be re-charged. Generally, full re-charging will require the vehicles engine to be running, where the alternator in the vehicle will supply the requisite charge to the caddy cart battery through the vehicle battery. After a suitable period of time, when re-charging is complete, the caddy cart battery 3 is removed from the cradle 10, the electrical connections removed, and the battery 3 is then ready for re-use in a caddy cart.

Referring to FIG. 2, there is illustrated an alternative embodiment of the invention in which parts similar to those identified with reference to the previous embodiment are assigned the same reference numerals. In this embodiment, an electronic charge varying device 20 is provided in the circuit such that charge provided to the caddy cart battery 3 passes through the device 20. The device 20 includes means for sensing the level of charge required by the battery 3 and has two charge settings, a first “full charge” setting in which a full charge of electricity from the vehicle battery is supplied to the caddy cart battery, and a “trickle charge” setting which allows only a small amount of charge to be supplied to the caddy cart battery

The use of this embodiment of the invention is similar to that described with reference to the previous embodiment with the exception that, when an empty battery is connected to the device 20, it will sense that a full charge needs to be provided to the battery and will operate in “full charge” setting. When the relay senses that the battery has been re-charged, it will switch to a “trickle charge” setting where only a small charge is provided to the battery.

Referring to FIG. 3, there is illustrated an alternative embodiment of the invention in which parts similar to those identified with reference to the previous embodiment are assigned the same reference numerals. In this embodiment, the circuit additionally includes a charge level indicator 30 which allows a user to know when the caddy cart battery 3 has been fully recharged. The details of such charge level indicators 30 will be well known to those skilled in the art and will not be further described herein. The use of this embodiment of the invention is similar to that described with reference to the previous embodiment with the exception that, when a caddy car battery has been re-charged, a green indicator light will illuminate on the charge level indicator. Further, when the battery is in the process of re-charging, a red light will be illuminated.

Although it is not described herein, the electronic charge varying device (and the charge level indicator) may be attached to the cradle. Upon use, the battery is inserted into the cradle and the adapter of the battery is wired up to the cut-off relay, which itself is connected to the electrical cable. In a different embodiment, the charge level indicator may form part of the cut-of relay.

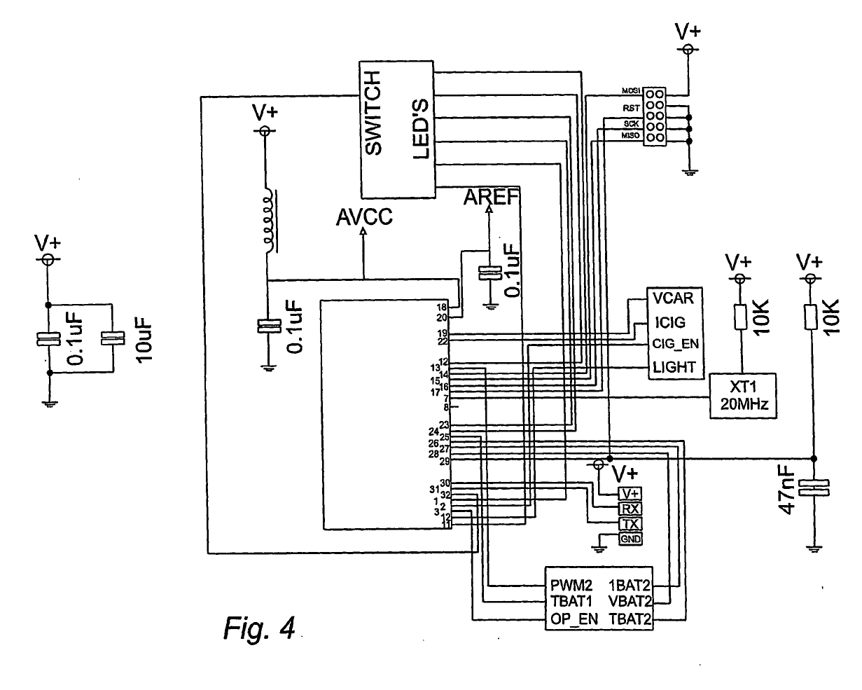

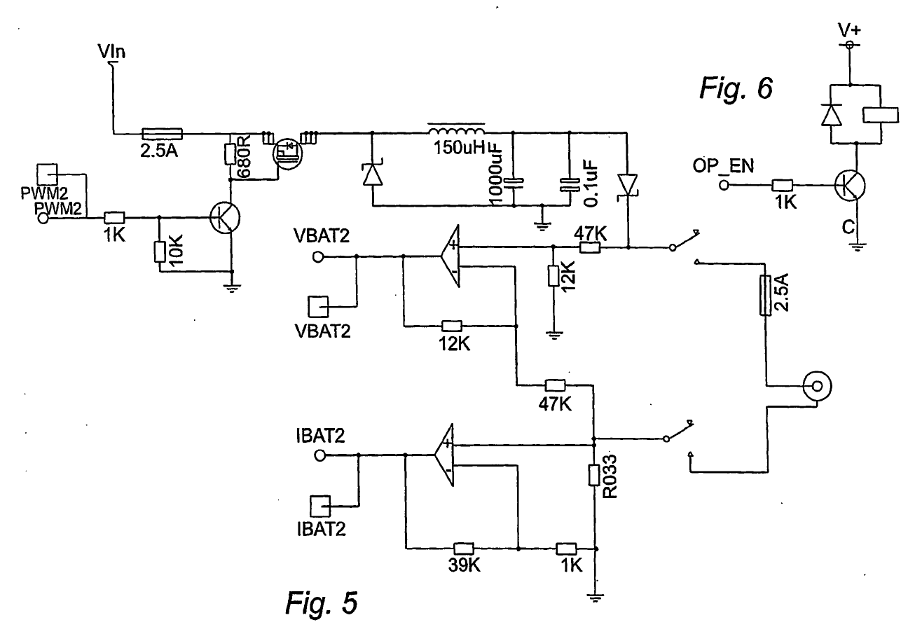

FIG. 4 shows the circuit diagram of a printed circuit board of the caddy cart battery charger. This comprises circuits and elements disclosed hereinafter.

The printed circuit board connects the vehicle battery to the caddy cart battery and regulates the charging of the caddy cart battery. The printed circuit board converts the input voltage from the vehicle battery to an output voltage suitable for charging the caddy cart battery.

The printed circuit board also comprises thermistors (not shown) that are arranged to prevent overheating of the caddy cart battery. Overheating can occur by overcharging of the caddy cart battery.

The charging time may vary depending on the type of vehicle, the size or capacity of the battery and the driving conditions of the vehicle. It is estimated that following 18 holes of golf, a battery would take approximately two to three hours to re-charge to a fully-charged state.

The charging rate may be diminished due to the use of air conditioning, heated rear and front windows, windscreen wipers etc. as it depends on the capacity of the vehicle battery.

FIG. 6 shows the relay switch circuit. The relay circuit maintains a small flow, a trickle, of charge into the battery when it is fully charged in order to maintain its charged state.

The relay circuit also breaks the flow of charge to the caddy cart battery when the vehicle is not in use, or is stationary for an extended period.

The battery can be charged while the vehicle is in motion. When the vehicle is not being used or when the engine is not running, the relay disconnects the vehicle battery from the caddy cart battery.

This reduces the possibility of either system damaging or discharging the other by substantially eliminating any over charging or over heating of the battery. Typically, the life span of the battery is improved by reducing or eliminating over charging or over heating.

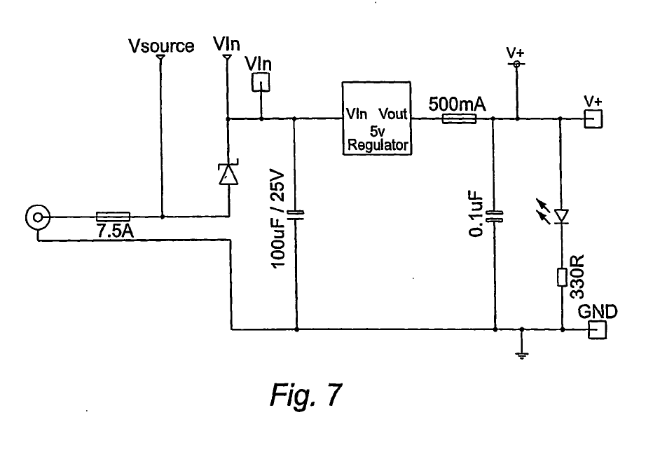

FIG. 7 shows a the circuit of a relay comprising part of the relay circuit of FIG. 6.

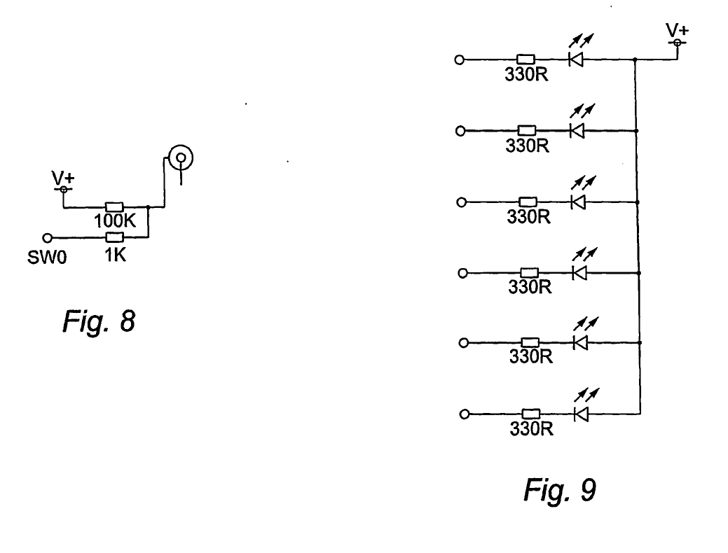

FIG. 8 shows the boot light switch circuit, this is arranged to break the caddy cart battery charging circuit when the boot of the vehicle is opened. Such a circuit prevents tampering of with the battery when it is charging and reduces the likelihood of accidents.

FIG. 9 shows the light emitting diodes circuit. The cradle also incorporates six indicator LEDs, which indicate the level of charge within the caddy cart battery. The LEDs may be colour coded, for example red indicates reflects a low level of charge, yellow an intermediate level of charge and green indicates that the battery is fully charged and ready for use.

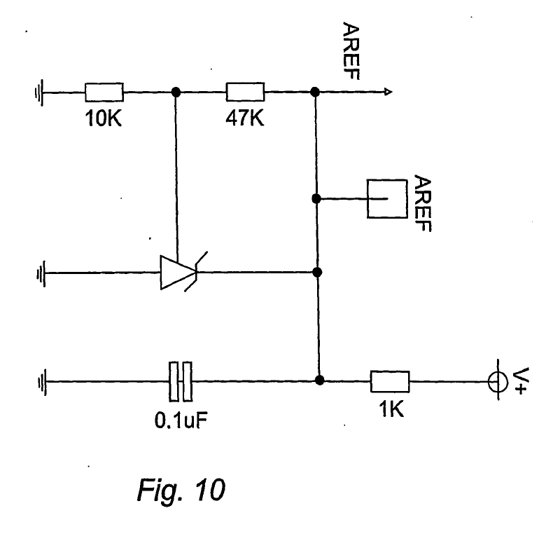

FIG. 10 shows an earthing circuit, this reduces the likelihood of a user of the caddy cart charger electrocuting themselves:

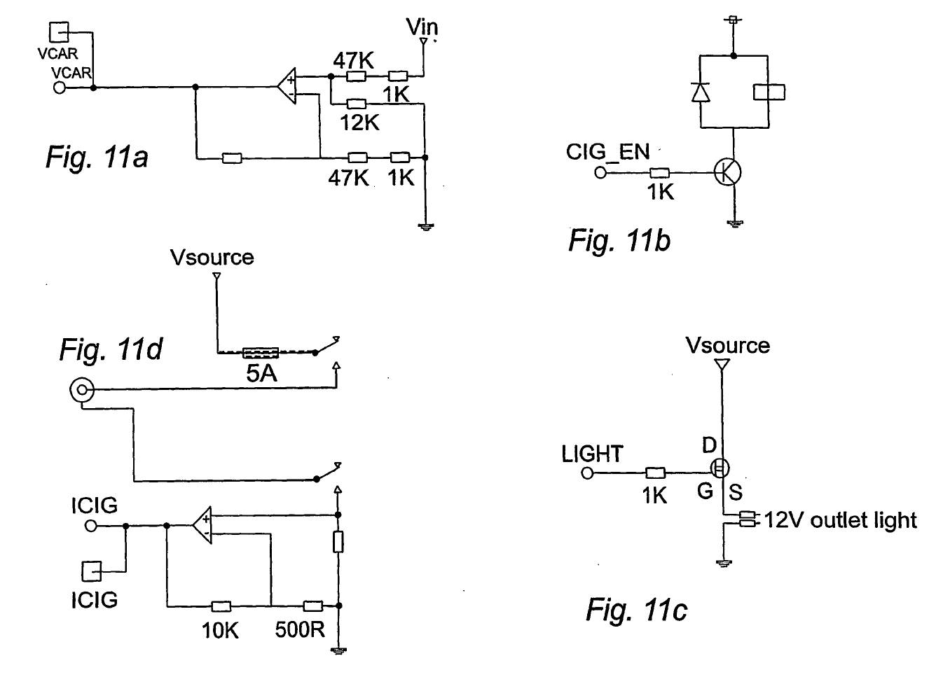

FIGS. 11a-11d shows the cigarette lighter circuit. This cigarette lighter circuit is a cigarette lighter type power source and is incorporated into the cradle provides a power source for other accessories, such as a lamp unit or a heated flask.

The invention is not limited to the embodiments hereinbefore described which may be varied in construction and detail without departing from the spirit of the invention. For example, the invention is also applicable to re-charging other types of batteries which are similar to caddy cart batteries, such as, for example, electric wheelchair batteries and the like.

1. A method of recharging a caddy cart battery, comprising the step of connecting the caddy car battery to an electrical supply of a vehicle to thereby charge the caddy cart battery.

2. A method as claimed in claim 1 in which the caddy cart battery is connected directly to the vehicle battery.

3. A method as claimed in claim 1 or 2 which employs charge varying means to decrease the electrical supply to the caddy cart battery when the caddy car battery is recharged, wherein the charge passing from the vehicle battery to the caddy car battery passes through the cut-off relay.

4. A method as claimed in claim 1 which employs an electrical cable having a first end which is adapted to make an electrical connection with a battery of a passenger carrying vehicle, and a second end which is adapted to make an electrical connection with a caddy cart battery.

5. A method as claimed in any preceding claim, which additionally employs a cradle for the caddy cart battery, which method includes the step of placing the caddy cart battery in the cradle, and then re-charging the caddy cart battery.

6. A kit for re-charging a caddy cart battery comprising:
an electrical cable having a first end which is adapted to make an electrical connection with a passenger vehicle battery, and a second end which is adapted to provide charge to a caddy cart battery; and
instructions for electrically connecting the vehicle battery and the caddy cart battery using the electrical cable.

7. A kit as claimed in claim 1 further including an electronic charge varying device to decrease the electrical supply to the caddy cart battery when the caddy cart battery is recharged.

8. A kit as claimed in claim 8 in which the charge varying device is provided in-line in the electrical cable.

9. A kit as claimed in any of claims 6 to 8 which further includes a cradle which is dimensioned to receive a caddy cart battery.

10. A kit as claimed in claim 9 in which the charge varying device is provided on the cradle, wherein the device is adapted for making an electrical connection with the electrical cable and the caddy cart battery.

11. A kit as claimed in any of claims 6 to 10 further including a charge level indicator which provides an indication of when the caddy car battery has been re-charged.

12. A kit as claimed in claim 11, when dependant on claim 9, in which the charge level indicator is provided on the cradle.

13. A kit as claimed in any of claims 9 to 12 in which the cradle is adapted to be fixedly mounted in a boot of a passenger vehicle.

14. A kit as claimed in any of claims 6 to 13 in which the electrical cable is of a sufficient length to reach from a battery of a passenger vehicle to a boot of the passenger vehicle.

15. A kit as claimed in any of claims 6 to 14 further including:
at least one adapter for making an electrical connection between a first end of the electrical cable and a passenger vehicle battery;
at least one adapter for making an electrical connection between the second end of the electrical cable and the caddy cart battery, or an adapter for the caddy cart battery, or an electronic charge varying device in electrical connection with the caddy cart battery.

16. A passenger vehicle comprising an electrical cable which is adapted to provide charge from a battery of the passenger vehicle to a battery of a caddy cart, and, optionally, instructions for recharging a caddy cart battery using the electrical cable.

17. A passenger vehicle as claimed in claim 16 in which an end of the electrical cable which is adapted to provide charge to the caddy cart battery is located in a boot of the passenger vehicle.

18. A passenger vehicle as claimed in claim 17 further including a socket located in the boot of the vehicle, which socket is dimensioned to receive and hold the caddy cart battery.

19. A passenger vehicle as claimed in any of claims 17 to 19 further including an electronic charge varying device which is adapted to decrease the electrical supply to the caddy cart battery when the caddy cart battery is recharged.

20. A method, kit, or passenger vehicle according to any of claims 1 to 19, in which the charge varying device has a first setting which allows full electrical charge to be supplied to the caddy cart battery when the caddy cart battery is being recharged, and a second setting which allows a trickle charge to the caddy cart battery when it is recharged.
